(19) United States
(12) Patent Application Publication
(10) Pub. No.: US 2026/0160875 A1
(43) Pub. Date: Jun. 11, 2026

(54) METHOD FOR OPERATING A SENSOR DEVICE

(71) Applicant: HELLA GMBH & CO. KGAA, Lippstadt (DE)

(72) Inventors: Etienne Costa-Patry, Berlin (DE); Vivek Bakul Maru, Berlin (DE)

(21) Appl. No.: 19/180,291

(22) Filed: Apr. 16, 2025

(30) Foreign Application Priority Data
Apr. 17, 2024 (DE) 102024110730.8

(51) Int. Cl. G01S 13/04; B60R 25/10; B60R 25/31; G01S 13/02

(52) U.S. Cl. CPC G01S 13/04; B60R 25/1004; B60R 25/31; G01S 13/0209

(57) ABSTRACT

The invention relates to a method for operating a sensor device, in particular a UWB sensor device. The UWB sensor device is configured to monitor an interior space of a vehicle, providing different vehicle functions for the vehicle, including burglary protection, access control, interior space presence detection and/or child presence detection, wherein the various vehicle functions are provided depending on the detection of movement inside or outside the vehicle. The sensor device has at least one sensor unit for monitoring at least one row of seats in the interior space of the vehicle. The method includes: detecting a sensor signal with the sensor device; examining the sensor signal using classified signal types; evaluating the sensor signal depending on the examination; and providing a corresponding functionally substantial vehicle function depending on the evaluation.

### CROSS-REFERENCE TO RELATED APPLICATIONS

The present application claims the benefit of German Patent Application No. 10-2024-110-730.8, filed Apr. 17, 2024, the disclosure of which is incorporated by reference.

### FIELD OF THE INVENTION

The invention relates to a method for operating a sensor device, in particular an ultra-wideband (UWB) sensor device. Furthermore, the invention relates to a corresponding computer program product, a corresponding control unit and a corresponding sensor device, in particular a UWB sensor device, for carrying out a corresponding method.

### BACKGROUND OF THE INVENTION

UWB sensor units are increasingly being installed in modern vehicles. The UWB sensor units can be used to detect people in the interior space of the vehicle. The UWB sensor units can detect the transit time of sensor signals reflected by people who are in the interior space of the vehicle. The distance to the persons can be determined based on the transit time of the sensor signals. The Doppler shift of the sensor signals can be used to detect a person's movements, e.g. when breathing, so that their chest moves. Furthermore, vital parameters of the person, such as breathing rate, can be determined. A disadvantage of the known sensor units is that the detection from inside the vehicle cannot be distinguished from the detection outside the vehicle, as UWB signals can pass through closed windows. The distance or transit time of the sensor signals is not reliable information for distinguishing between inside and outside, as the radial distance of an animal lying in the footwell and an adult standing close to the outside of the vehicle can be the same.

### SUMMARY OF THE INVENTION

It is therefore the object of the present invention to at least partially overcome at least one of the disadvantages described above. In particular, it is the object of the invention to provide an improved method for operating a sensor device, in particular a UWB sensor device, which is designed (primarily) for monitoring an interior space of a vehicle, which has an extended functionality to provide different functionally substantial vehicle functions for the vehicle, comprising a burglary protection, an access control, an interior space presence detection, a child presence detection, etc., wherein the different functionally substantial vehicle functions are provided in dependence on a detection of a movement inside or outside the vehicle. Preferably, the object of the invention is to provide an improved method for operating a sensor device, in particular a UWB sensor device, which enables improved presence detection in the interior space and in the exterior space of the vehicle, which has improved accuracy, which enables improved monitoring functions, which reduces or even avoids false alarms, which increases customer comfort and which increases confidence in the vehicle functions. Furthermore, it is the object of the present invention to provide a corresponding computer program product, a corresponding sensor device, in particular a UWB sensor device, for carrying out a corresponding method.

The present invention provides a method for operating a sensor device, in particular a UWB sensor device. Furthermore, the invention provides a corresponding computer program product, a corresponding control unit, and a corresponding sensor device, in particular a UWB sensor device. Features and details described in connection with the various embodiments and/or aspects of the invention naturally also apply in connection with the other embodiments and/or aspects and vice versa, so that reference is or can always be made reciprocally with respect to the disclosure of the individual embodiments and/or aspects.

The present invention provides: a method for operating a sensor device, in particular a UWB sensor device, which is designed (primarily) for monitoring an interior space of a vehicle (which is given extended functionality within the scope of the invention), in order to provide various functionally substantial vehicle functions for the vehicle based on interior space and/or exterior space detection. Various vehicle functions are conceivable, including, for example, burglary protection, access control, interior space presence detection and/or child presence detection, etc. The various functionally substantial vehicle functions are advantageously provided as a function of a detection of a movement inside or outside the vehicle.

The sensor device can have at least one sensor unit for monitoring at least one row of seats in the interior space of the vehicle. However, the sensor device can also comprise a plurality of sensor units for monitoring a plurality of rows of seats in the interior space of the vehicle. In principle, the sensor device can comprise one or a plurality of sensor units per row of seats.

The method has the following steps: detecting a sensor signal with the sensor device; examining (or in other words classifying) the sensor signal using classified signal types; evaluating the sensor signal depending on the examination; and providing a corresponding functionally substantial vehicle function depending on the evaluation.

It is recognized that sensor units, particularly UWB sensor units, with radar functions are increasingly being used in vehicles to provide various vehicle functions. In most cases, separate sensor units are used for the functions inside the vehicle, e.g. for detecting the presence of children, and other sensor units for the functions outside the vehicle, e.g. for detecting intruders. Such sensor units generally enable the detection and localization of movements.

The invention recognizes that such sensor units, such as UWB sensor units, often cannot detect from where the detection originates, from outside or inside the vehicle, as sensor signals, such as radar signals or UWB signals, can pass through non-conductive vehicle parts, such as plastic parts and/or windows.

The invention recognizes that the localization of detection outside or inside the vehicle is important for safe, reliable and error-free operation of the sensor units.

The distance itself (also known as transit time measurement) cannot provide reliable information to distinguish between detection outside or inside the vehicle, as, for example, a radial distance of an animal lying in the footwell and an adult standing close to the outside of the vehicle can be the same.

This idea aims to improve the distinction between detection outside or inside the vehicle. A plurality of physical observations/regularities can be used in an advantageous way, as explained in detail below.

Sensor units arranged on the inside, such as UWB sensor units, can detect outside the vehicle in direct visual contact, e.g. through adjacent side windows and, for the first row, through a windshield and, for the last row, through a tailgate window. The sensor signals, e.g. UWB sensor signals, can also be attenuated, e.g. by a closed pane with a metallized layer or similar.

A person outside the vehicle usually approaches or leaves the vehicle first. This walking/running movement differs from other detectable movements, such as breathing, moving the arms, turning, etc., and generates a recognizable sensor signal, e.g. UWB signal. This recognizable sensor signal, e.g. UWB signal, can be assigned to a type A, for example.

Other detectable movements are, for example, vital movements such as breathing, moving the arms, slightly turning the head or upper body, etc. These other detectable movements also generate a recognizable sensor signal, e.g. UWB signal. This recognizable sensor signal, e.g. UWB signal, can be referred to as a type B signal.

Furthermore, sensor signals, e.g. UWB signals, can also be recognized if nothing is happening in the vicinity and/or inside the vehicle, and can be referred to as a type C signal.

In principle, different signal types can be created for corresponding movements (type A, B, C, D, E, . . . ). The signal types A, B and C described as examples above are not exhaustive. Different signal types (type A, B, C, D, E, . . . ) can be provided for different movements. Different signal types can be combined in different orders to form identifiable signal sequences. The different signal sequences can be provided for corresponding functionally substantial vehicle functions. A plurality of signal types can be classified using physical and/or machine learning algorithms, e.g. by placing a sliding time window over an incoming sensor signal, e.g. UWB signal. The recognized signal types and/or signal sequences can be translated into a description of the situation using the invention.

An exemplary sequence is described in the following example, in which someone approaches the vehicle from behind, remains in the vicinity and then moves away again.

| | 1^{st} time | 2^{nd} time | 3^{rd} time | 4^{th} time |
|---|---|---|---|---|
| Front row UWB | Type C | Type C | Type C | Type C |
| Rear row UWB | Type C | Type A | Type B | Type A |

In the example shown in the table, the sensor device can have a sensor unit (so-called “Front row UWB”) for a front row of seats and a sensor unit (so-called “Rear row UWB”) for a rear row of seats. In the example shown in the table, the sensor signal can be analyzed or classified using a sliding time window (1 st time, 2nd time, 3rd time, 4th time, etc.), which is passed over an incoming sensor signal.

Various functionally substantial vehicle functions can use the recognized signal types and/or signal sequences to make their operation safer, more reliable and more convenient.

In the case of detecting the presence of children, for example, a sensor signal of type B can be similar to a sensor signal generated in the vehicle, which can lead to a possible malfunction. For this reason, sensor signals of type A (incoming and/or outgoing) can be used as markers for a start and/or an end of a sensor signal generated from outside the vehicle. In other words, the arrival of an outside person (type A signal) can be clearly recognized and interpreted as the start of an external disturbance, so that the vehicle function (detection of the presence of children) can delay its decision until this disturbance has disappeared (again type A sensor signal). In this manner, the risk of a false alarm in the vehicle function (detection of the presence of children) due to external interference can be significantly reduced. If the fault (in this case a type B sensor signal) persists after a certain time, the function can carry out the evaluation with the available signals. If a sensor signal of type A is received after a further period of time, it can be detected that the person standing outside is moving away from the vehicle again. In this manner, the vehicle function (detection of the presence of children) can recognize that the sensor signal of type B has been detected due to external interference. An alarm for the detection of the presence of children can be omitted.

In the event of burglary detection, the arrival of a stranger (type A signal) could, for example, be transmitted to a burglar warning system and/or even activate the burglar warning system, as a burglary can only occur if someone is near a window of the vehicle. Thus, the use of the internally arranged sensor device can help to reduce, preferably minimize, the risk of a false alarm during a vehicle function (burglary detection or burglary protection).

In principle, it is conceivable that the examination or classification of the sensor signal is carried out using a sliding time window over an incoming sensor signal.

Furthermore, the method may have, for example, before the examination, dividing the sensor signal into signal portions that follow one another in time. Dividing the sensor signal into signal portions that follow one another in time can be carried out, for example, by using a specific time window over an incoming sensor signal. Thus, an improved detection of signal types and/or signal sequences can be carried out in a simple way.

It is also possible to classify the signal types by detecting, localizing and examining different movement sequences inside and outside the vehicle. In this manner, different movement sequences can be learned inside and outside the vehicle, which can be used to provide various functionally substantial vehicle functions.

Furthermore, it can be provided that the signal types are classified before commissioning and/or during operation of the sensor device. In this manner, a learned and/or constantly improving sensor device can be provided that can generate advantageous signals, even ready-made control signals, for various functionally substantial vehicle functions.

It is also possible to classify the signal types using physical examination methods and/or machine learning methods. This can be done in advance, before commissioning the sensor device, and/or during operation of the sensor device.

It can also be provided that the signal types have at least one first signal type which is specific to a person approaching and/or moving away from the vehicle from outside. Such a sensor signal has a specific shape that is easily recognizable and can be distinguished from other signals. Such a sensor signal can provide many different benefits.

Advantageously, the first type of signal can be used as a marker for detection outside the interior space of the vehicle. In this manner, a simple but also safe and reliable distinction can be made between detection from inside or outside the vehicle.

Further advantages can arise if the first signal type is used for a burglary protection system and/or access control. In this manner, extended vehicle functions can be enabled by the sensor device, which are not only based on interior space monitoring, but also improve exterior space monitoring.

Advantageously, the first signal type can be used to activate a burglary protection system. In this manner, false alarms can be easily, reliably and safely avoided with the burglary protection system.

Advantageously, the first signal type can be used to activate an access control system of the vehicle. For example, the first signal type can be used to initiate an authentication request from an authorized user. The sensor device can therefore improve the functionality of an access control system and, in particular, reduce hardware components for presence detection outside the vehicle.

Further advantages can arise if the first signal type is used to verify false detections and/or avoid false alarms in an interior space presence detection, particularly a child presence detection. Since the first type of signal is specific to a presence detection outside the vehicle, it can provide a simple check for an interior space presence detection, particularly a child presence detection, to preferably reduce, particularly avoid, interference from outside the vehicle.

Furthermore, the signal types can have at least one second signal type, which is specific to a person breathing and/or moving within the vehicle. Advantageously, the second signal type can be used for an interior space presence detection, in particular a child presence detection.

Furthermore, the signal types can have at least a third signal type, which is specific to a rest situation when no movement is detected inside and/or outside the vehicle. This sensor signal can be used to differentiate between the other signal types and/or even to standardize the sensor signals.

According to a further advantage of the method, different signal sequences can be classified with certain successive signal types for corresponding functionally substantial vehicle functions. The sensor device can thus support, improve and/or ensure a wide range of functionally substantial vehicle functions.

The present invention provides: a computer program product comprising instructions which, when the computer program product is executed by a computer, cause the computer to perform a procedure which may proceed as described above. With the aid of the computer program product, the same advantages described above in connection with the method according to the invention can be achieved. Full reference is made to these advantages in the present case.

The present invention provides: a control unit, having a computing unit and a memory unit, in which a code is stored which, when at least partially executed by the computing unit, carries out a method which can run as described above. With the aid of the control unit, the same advantages can be achieved as described above in connection with the method according to the invention. Full reference is made to these advantages in the present case.

Preferably, an artificial neural network can be stored in the memory unit, which is specially trained to classify the signal types. In addition or instead, a map comprising the classified signal types can be stored in the memory unit.

The present invention provides: a sensor device, in particular a UWB sensor device, having a corresponding control unit which is specially designed to carry out a method which can run as described above. With the aid of the sensor device, the same advantages can be achieved as described above in connection with the method according to the invention. Full reference is made to these advantages in the present case.

### BRIEF DESCRIPTION OF THE DRAWINGS

The invention is explained in more detail below with reference to the accompanying drawings. In the drawings:

FIG. 1 is an exemplary representation of signal types;

FIG. 2 is an exemplary representation of a sensor device; and

FIG. 3 is an exemplary visualization of a proposed method.

### DETAILED DESCRIPTION OF THE CURRENT EMBODIMENT

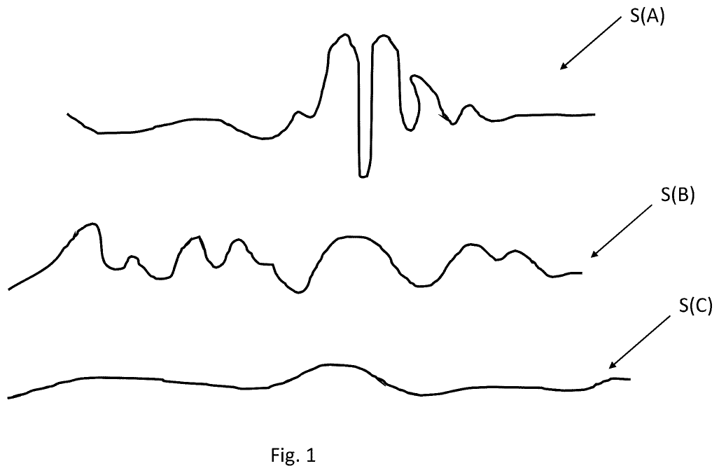

FIGS. 1, 2 and 3 serve to explain a method within the meaning of the invention, which was developed for operating a sensor device 100, for example in the form of a UWB sensor device. The sensor device 100 is designed (primarily) to monitor an interior space 201 of a vehicle 200. With the aid of the invention, the sensor device 100 is provided not only with improved interior space monitoring functionality, but also with extended functionality for exterior space monitoring.

The sensor device 100 can thus be used to provide different functionally substantial vehicle functions F1, F2, based on interior space and/or exterior space detection, for the vehicle 200. Various vehicle functions F1, F2 are conceivable, e.g. burglary protection, access control, interior space presence detection and/or child presence detection, etc.

The different functionally substantial vehicle functions F1, F2 may advantageously be provided in response to a detection of a movement inside or outside the vehicle 200 (or, in other words, in response to a distinction between a detection outside or inside the vehicle 200).

The sensor device 100 may include at least one sensor unit 10, 20 for monitoring at least one row of seats in the interior space 201 of the vehicle 200. Furthermore, the sensor device 100 may comprise a plurality of sensor units 10, 20 for monitoring a plurality of rows of seats in the interior space 201 of the vehicle 200. In principle, the sensor device 100 can comprise one or a plurality of sensor units 10, 20 per row of seats.

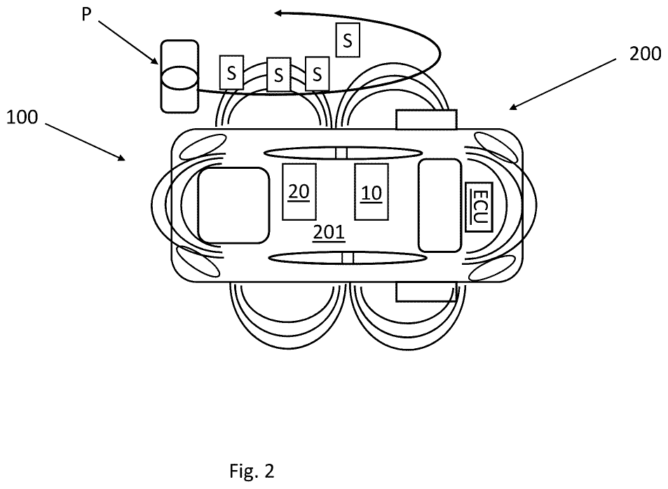

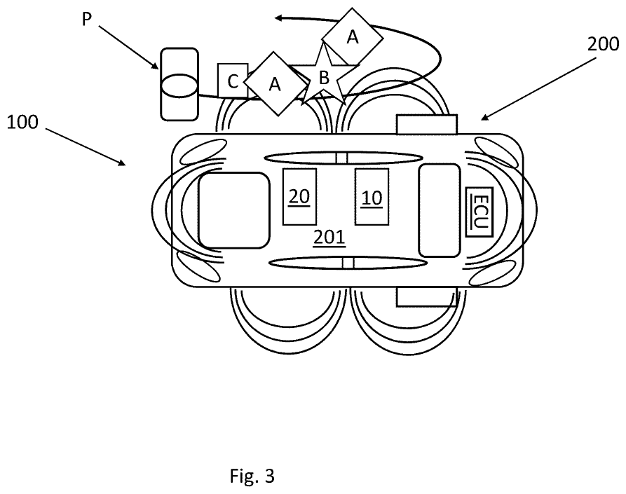

As FIGS. 2 and 3 merely indicate by way of example, the sensor device 100 can have a sensor unit 10 (so-called “Front row UWB”) for a front row of seats and a sensor unit 20 (so-called “Rear row UWB”) for a rear row of seats.

The method has the following steps: detecting a sensor signal S by the sensor device 100 (see FIG. 2); examining the sensor signal S using classified signal types A, B, C (see FIG. 1); evaluating the sensor signal S depending on the examination (see FIG. 3); and providing a corresponding functionally substantial vehicle function F1, F2 depending on the evaluation.

In one aspect, the invention recognizes that sensor units 10, 20, such as UWB sensor units, often cannot detect where a detection originates from, from outside or inside the vehicle 200, since sensor signals, such as radar signals or UWB signals, can pass through non-conductive vehicle parts, such as plastic parts and/or windows.

Secondly, the invention recognizes that the localization of the detection outside or inside the vehicle 200 is important for safe, reliable and error-free operation of the sensor units 10, 20.

The information about a distance to the detected object per se cannot provide reliable information to distinguish between the detection outside or inside the vehicle 200, since, for example, a radial distance of an animal lying in the footwell and an adult standing close outside the vehicle 200 may be the same.

The method can be used to quickly, safely and reliably differentiate between detection outside or inside the vehicle 200.

As indicated in FIG. 2, one insight that can be used in an advantageous manner is that sensor units 10, 20 arranged on the inside, such as UWB sensor units, can detect outside the vehicle 200 in direct visual contact, for example through adjacent side windows. The sensor unit 10 for the first row can also detect through a windshield and the sensor unit 20 for the last row can also detect through a tailgate window.

As FIGS. 2 and 3 illustrate, a person P outside the vehicle 200 generally walks towards or away from the vehicle 200 first. This walking/running movement differs from other detectable movements, such as breathing, moving the arms, turning, etc., and generates a recognizable sensor signal S, e.g. UWB signal. This recognizable sensor signal S, e.g. UWB signal, can be assigned to a type A, for example, see FIG. 1.

Other detectable movements, e.g. vital movements such as breathing, moving the arms, slightly turning the head or upper body, etc., also generate a recognizable sensor signal S, e.g. UWB signal. This recognizable sensor signal S, e.g. UWB signal, can be referred to as type B signal, see FIG. 1.

Furthermore, sensor signals, e.g. UWB signals, are also recognizable if there is no detection of movements in the vicinity and/or within the vehicle 200, and can be referred to as a type C signal, see FIG. 1.

In principle, various other signal types can be created for corresponding movements, e.g. signal type D, E, . . . . Different signal types A, B, C can be combined in different orders to form identifiable signal sequences. The different signal sequences can be provided for corresponding functionally substantial vehicle functions F1, F2. A plurality of signal types A, B, C can be classified using physical and/or machine learning algorithms, e.g. by placing a sliding time window over an incoming sensor signal, e.g. UWB signal. The detected signal types A, B; C and/or signal sequences can be translated into a description of the situation using the invention.

An exemplary signal sequence is described in the following example, in which a person P approaches the vehicle from behind, stops nearby and moves away again, as shown in FIGS. 2 and 3.

| | 1^{st} time | 2^{nd} time | 3^{rd} time | 4^{th} time |
|---|---|---|---|---|
| Front row UWB | Type C | Type C | Type C | Type C |
| Rear row UWB | Type C | Type A | Type B | Type A |

In the example shown in the table, the sensor device 100 can have a sensor unit (so-called “Front row UWB”) for a front row of seats and a sensor unit (so-called “Rear row UWB”) for a rear row of seats.

In the example shown in the table, the sensor signal S can be analyzed or classified using a sliding time window (1st time, 2nd time, 3rd time, 4th time, etc.), which is passed over an incoming sensor signal.

Various functionally substantial vehicle functions F1, F2 can use the recognized signal types A, B, C and/or signal sequences to make their operation safer, more reliable and more convenient.

For example, in the case of the example described in FIGS. 2 and 3, a sensor signal S of type B can be similar to a sensor signal S generated in the vehicle 200 when a presence of children is detected, which can lead to a possible malfunction in the vehicle function F1 (detection of a presence of children).

For this reason, sensor signals of type A (incoming and/or outgoing) can be used as markers for a start or an end of a sensor signal S generated from outside the vehicle 200. In other words, the arrival of an external person P (type A signal) can be detected and interpreted as the start of an external disturbance, so that the vehicle function F1 (detection of the presence of children) can delay its decision until this disturbance has disappeared (type A sensor signal again). In this manner, the risk of a false alarm in the vehicle function F1 (detection of the presence of children) due to external interference can be significantly reduced. If the fault (in this case a sensor signal of type B) persists after a certain time, the sensor device can carry out the evaluation with the available signals. If a sensor signal of type A is received after a further period of time, it can be detected that the person P standing outside is moving away from the vehicle 200 again. In this manner, the vehicle function F1 (detection of the presence of children) can recognize that the sensor signal of type B has been detected due to external interference. An alarm to detect the presence of children can be safely omitted in this case.

In the case of a vehicle function F2 (burglary detection or burglary protection), the arrival of a stranger P (signal of type A) can be transmitted to a burglar warning system, for example. Advantageously, a type A sensor signal can be used to activate the burglar alarm system. As a burglary can only occur if someone is in the vicinity of a window of the vehicle 200, valuable information can be provided for the vehicle function F2 (burglary detection or burglary protection). Thus, the use of the internally arranged sensor device 100 can help to avoid false alarms in the vehicle function F2 (burglary detection or burglary protection).

In principle, it is conceivable that the sensor signal S can be examined using classified signal types A, B, C with the aid of a sliding time window (1st time, 2nd time, 3rd time, 4th time, etc.) over an incoming sensor signal S (see FIG. 1).

As indicated in the table above, the method may also include, for example before examining or classifying the sensor signal S: dividing the sensor signal S into signal portions Si that follow one another in time.

The division of the sensor signal S into signal portions that follow one another in time can be carried out, for example, by using a specific time window (1st time, 2nd time, 3rd time, 4th time, etc.) over an incoming sensor signal S.

Thus, an improved detection of signal types A, B; C and/or signal sequences can be carried out in a simple way.

Advantageously, the signal types A, B, C can be classified by detecting, localizing and examining different movement sequences inside and outside the vehicle 200.

The signal types A, B, C can be classified before commissioning and/or during operation of the sensor device 100, for example using physical examination methods and/or machine learning methods.

As indicated in FIG. 1, the signal types A, B, C may comprise at least a first signal type A, which is specific for an approach and/or distance of a person P from outside to the vehicle 200. Such a sensor signal S has a specific shape that is easily recognizable and can be distinguished from other sensor signals S of type B or C. Such a sensor signal S can provide many different benefits.

Advantageously, the first signal type A can be used as a marker for detection outside the interior space 201 of the vehicle 200. The first signal type A may be used for a burglary protection system and/or an access control system to enable advanced vehicle functions F1, F2 by the sensor device 100, which are not only based on interior space monitoring but also enhance exterior space monitoring.

Advantageously, the first signal type A can be used to activate a burglary protection system. In this manner, false alarms can be easily, reliably and safely avoided with the burglary protection system.

Advantageously, the first signal type A can be used to activate an access control system of the vehicle. For example, the first signal type A can be used to initiate an authentication request from an authorized user.

Further advantages can be provided by the first signal type A in an interior space presence detection, especially a child presence detection, to verify false detections and/or avoid false alarms. Since the first type of signal A is specific to a presence detection outside the vehicle, it can provide a simple check for an interior space presence detection, particularly a child presence detection, to preferably reduce, particularly avoid, interference from outside the vehicle.

As indicated in FIG. 1, the signal types A, B, C can have at least a second signal type B, which is specific for breathing and/or movement of a person within the vehicle 200. Advantageously, the second signal type B can be used for an interior space presence detection, in particular a child presence detection.

As indicated in FIG. 1, the signal types A, B, C can have at least a third signal type C, which is specific to a rest situation when no movement is detected inside and/or outside the vehicle 200. This signal type C can be used to standardize the sensor signals S.

Furthermore, the invention relates to a corresponding computer program product, a corresponding control unit ECU and a corresponding sensor device 100, in particular a UWB sensor device, for carrying out a corresponding method.

The foregoing explanation of the embodiments describes the present invention solely by way of examples. Of course, individual features of the embodiments can be freely combined with one another, provided this makes technical sense, without going beyond the scope of the present invention.

### LIST OF REFERENCE NUMBERS

100 sensor device
10 sensor unit
20 sensor unit
200 vehicle
201 interior space
A signal type
B signal type
C signal type
S sensor signal
F1 vehicle function
F2 vehicle function
P person
ECU control unit
time time window

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for operating an ultra-wideband (UWB) sensor device to monitor an interior space of a vehicle and to provide different vehicle functions for the vehicle including burglary protection, access control, interior space presence detection, or child presence detection, wherein the different vehicle functions are provided depending on the detection of movement inside or outside of the vehicle, wherein the UWB sensor device has a sensor unit for monitoring at least one row of seats in the interior space of the vehicle, the method comprising:
detecting a sensor signal with the UWB sensor device;
examining the sensor signal using classified signal types;
evaluating the sensor signal depending on the examination; and
providing a corresponding vehicle function depending upon the evaluation.

2. The method of claim 1, wherein classification of the sensor signal is performed using a sliding time window over an incoming sensor signal.

3. The method of claim 2, wherein the signal types are classified by detecting, localizing, and examining different movement sequences inside and outside the vehicle.

4. The method of claim 2, wherein the signal types are classified before or during operation of the sensor device.

5. The method of claim 2, wherein the signal types are classified using physical examination methods or machine learning methods.

6. The method of claim 1, wherein the signal types comprise a first signal type which is specific for an approach or distance of a person from outside of the vehicle.

7. The method of claim 6, wherein the first signal type is used as a marker for detection outside the interior space of the vehicle.

8. The method of claim 6, wherein:
the first signal type is used for a burglary protection system or an access control system;
the first signal type is used to activate a burglary protection system;
the first signal type is used to activate an access control system of the vehicle; or
the first signal type is used to initiate an authentication request of an authorized user.

9. The method of claim 6, wherein the first signal type is used to verify false detections or to avoid false alarms during an interior space presence detection.

10. The method of claim 6, wherein the signal types comprise a second signal type which is specific for breathing or moment of a person within the vehicle.

11. The method of claim 10, wherein the second signal type is used for an interior space presence detection.

12. The method of claim 10, wherein the signal types comprise a third signal type which is specific for a rest situation when no detection of a movement inside or outside the vehicle takes place.

13. The method of claim 1, wherein different signal sequences are classified with certain consecutive signal types for corresponding vehicle functions.

14. A computer program comprising instructions in non-transitory computer readable memory that, when executed by a computer, cause the computer to perform the method of claim 1.

15. An electronic control unit comprising a computing unit and a memory unit in which machine-readable instructions are stored which, when executed by the computing unit, carries out the method of claim 1.

16. A sensor device having the electronic control unit of claim 15.
